(19) United States
(12) Patent Application Publication
(10) Pub. No.: US 2018/0221772 A1
(43) Pub. Date: Aug. 9, 2018

(54) ASSIGNING VALUES TO VIRTUAL ITEMS BASED ON REAL-WORLD PRICES

(71) Applicant: International Business Machines Corporation, Armonk, NY (US)

(72) Inventors: Christopher J. Hardee, Raleigh, NC (US); Steven R. Joroff, Tokyo (JP); Pamela A. Nesbitt, Ridgefield, CT (US); Scott E. Schneider, Rolesville, NC (US)

(21) Appl. No.: 15/428,740

(22) Filed: Feb. 9, 2017

(51) Int. Cl. A63F 13/65; G06Q 30/02; A63F 13/332; A63F 13/327; A63F 13/95; A63F 13/63

(52) U.S. Cl. CPC A63F 13/65; G06Q 30/0206; A63F 13/332; A63F 13/327; A63F 2300/6009; A63F 13/63; A63F 2300/69; A63F 2300/406; A63F 2300/208; A63F 13/95

(57) ABSTRACT

Techniques are provided for performing automated operations to assign virtual values to virtual items in a virtual world based on real-world commodity pricing. A request is received for a valuation within the virtual world of a first virtual item that includes a respective quantity of one or more virtual components. For each of the virtual components included in the first virtual item, a real-world commodity price of a real-world commodity associated with the virtual component is determined. Based at least in part on the determined real-world commodity prices and on the respective quantities of the virtual components included in the first virtual item, a virtual value is assigned to the first virtual item, and an indication is provided to the user of that assigned virtual value.

### BACKGROUND

This disclosure relates to virtual items in virtual environments and, more specifically, to assigning value to such items based on real-world prices.

Virtual reality and virtual environments or worlds, such as those created in video games, have recently enjoyed increased popularity. Such virtual worlds occasionally have complex economies that allow users of those worlds to buy, sell, trade, and even create virtual items and virtual commodities. Typically, such transactions are conducted using one or more virtual currencies that are associated with a particular virtual world. As virtual worlds and their corresponding economies increase in complexity, they can intentionally or unintentionally interact with the real world economy in various ways.

### SUMMARY

According to at least one embodiment, a method for assigning virtual values to virtual items in a virtual world is provided. The method is implemented by one or more computing systems and includes, for each of one or more virtual components included in the first virtual item, determining a real-world commodity price of a real-world commodity associated with the virtual component. The method further includes assigning, based at least in part on the determined real-world commodity prices and on the respective quantities of the one or more virtual components included in the first virtual item, a virtual value to the first virtual item.

According to another embodiment, a computer program product for assigning virtual values to virtual items in a virtual world based on real-world commodity pricing is provided. The computer program product includes a computer readable storage medium having program instructions embodied therewith that are executable by a computing system to cause the computing system to perform a method including receiving a request for a valuation within the virtual world of a first virtual item. The first virtual item includes a respective quantity of one or more virtual components. The method further includes, for each of the one or more virtual components included in the first virtual item, determining a real-world commodity price of a real-world commodity associated with the virtual component. The method further includes assigning, based at least in part on the determined real-world commodity prices and on the respective quantities of the one or more virtual components included in the first virtual item, a virtual value to the first virtual item. The method further includes providing an indication to the user of the assigned virtual value of the first virtual item.

According to another embodiment, a system is provided for assigning virtual values to virtual items in a virtual world based on real-world commodity pricing. The system includes one or more processors and at least one memory that includes instructions that, upon execution by a processor, cause the system to perform a method that includes receiving a request for a valuation within the virtual world of a first virtual item. The first virtual item includes a respective quantity of one or more virtual components. The method further includes, for each of the one or more virtual components included in the first virtual item, determining a real-world commodity price of a real-world commodity associated with the virtual component. The method further includes assigning, based at least in part on the determined real-world commodity prices and on the respective quantities of the one or more virtual components included in the first virtual item, a virtual value to the first virtual item. The method further includes providing an indication to the user of the assigned virtual value of the first virtual item.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

FIG. 1 depicts a block diagram of an exemplary network environment and computing system in accordance with one or more embodiments of the present invention.

FIG. 2 illustrates an example of assigning a virtual value to a virtual item in a virtual world in accordance with one or more embodiments of the present invention.

FIG. 3 depicts a process flow for operations by a Virtual Item Valuation (VIV) system in accordance with one or more embodiments of the present invention.

### DETAILED DESCRIPTION

A virtual economy (sometimes “synthetic economy”) is an emergent economy existing in a persistent virtual world, usually exchanging virtual goods in the context of a game played via network operations, such as over the Internet. Users typically enter these virtual economies for recreation and entertainment rather than necessity. As such, virtual economies typically lack particular aspects of a real economy that are not considered to be “fun.”

In certain scenarios, users of a virtual world interact with that world's virtual economy for “real” economic benefit. For example, a virtual world having a complex virtual economy can utilize one or more virtual currencies. In some scenarios, such virtual currencies can be traded at a constant or variable exchange rate with a real-world currency, such as if a creator of the virtual world offers a quantity of a virtual currency in exchange for a predetermined amount of US dollars.

One or more embodiments of the present invention described herein enable one or more processor-based computing systems to automatically perform operations for assigning virtual values to virtual items in a virtual world based on real-world commodity pricing. In particular, a virtual item can be linked to a counterpart real-world commodity, such that the virtual value of the virtual item changes over time in accordance with changes to the pricing of the counterpart real-world commodity. In one or more scenarios and embodiments of the present invention, some or all of the techniques described herein can be performed by an implementation of a Virtual Item Valuation (VIV) system, which can be operated as part of (or in conjunction with) one or more computing systems used to provide a virtual world to multiple users.

As used herein, the terms “virtual environment” or “virtual world” refer to any simulated setting in which multiple users interact and transact with one another and/or with computer-controlled entities designed to simulate other beings (and possibly other users). Such virtual worlds can be contrasted with the “real world,” in which physical human beings interact and transact one another, and manipulate physical objects. The term “virtual item,” also as used herein, can refer to any data structure representing a physical item within a virtual world. In various scenarios, a virtual item can include other virtual items as virtual components; the terms “virtual item” and “virtual component” can therefore be used interchangeably herein, unless context clearly dictates otherwise.

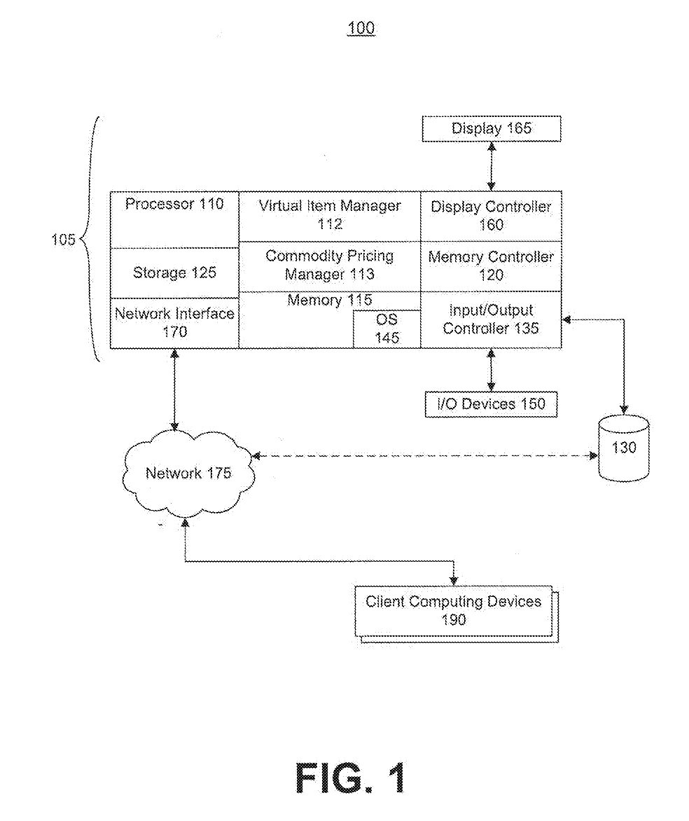

FIG. 1 illustrates a block diagram of a networked computing system 100 for use in practicing the teachings herein. The methods described herein can be performed or otherwise implemented via hardware, software (e.g., firmware), or combination thereof. In an exemplary embodiment, the methods described herein are implemented in hardware, and can be part of the microprocessor of a special or general-purpose digital computer, such as a personal computer, workstation, minicomputer, or mainframe computer. The computing system 100 therefore includes computer 105.

In the illustrated embodiment of FIG. 1, the computer 105 includes a processor 110, a virtual item manager module 112, a commodity pricing manager module 113, a memory 115 coupled to a memory controller 120, internal storage 125, and one or more input and/or output (I/O) devices 150 that are communicatively coupled to the computer 105 via a local input/output controller 135, which in the illustrated embodiment is further communicatively coupled to external storage 130. The input/output controller 135 can include one or more buses or other wired or wireless connections, as is known in the art. The input/output controller 135 can further include additional elements, which are omitted for simplicity, such as controllers, buffers (caches), drivers, repeaters, and receivers, to facilitate communications. Further, the local interface can include address, control, and/or data connections to facilitate appropriate communications among the aforementioned components.

Also in the illustrated embodiment, the processor 110 is a hardware device for executing hardware instructions or software, particularly that stored in memory 115. The processor 110 can be any custom made or commercially available processor, a central processing unit (CPU), an auxiliary processor among several processors associated with the general-purpose computer 105, a semiconductor based microprocessor (in the form of a microchip or chip set), a macroprocessor, or generally any device for executing instructions.

The memory 115 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 115 can incorporate electronic, magnetic, optical, and/or other types of storage media. Note that the memory 115 can have a distributed architecture, where various components are situated remote from one another, but can be accessed by the processor 110.

The instructions in the memory 115 can include one or more separate programs, each of which includes an ordered listing of executable instructions for implementing logical functions. In the example of FIG. 1, the instructions in the memory 115 include a suitable operating system (OS) 145. The operating system 145 typically controls the execution of other computer programs and can, among other capabilities, provide scheduling, input-output control, file and data management, memory management, and communication control and related services.

In an exemplary embodiment, I/O devices 150 can include, as non-limiting examples, a keyboard, mouse, printer, scanner, microphone, a network interface card (NIC) or modulator/demodulator (for accessing other files, devices, systems, or a network), a radio frequency (RF) or other transceiver, a telephonic interface, a bridge, a router, and other peripherals communicatively coupled to the computer 105 via input/output controller 135. In the depicted embodiment, the computing system 100 further includes a display controller 160 coupled to a display 165, and a network interface 170 communicatively coupled to a network 175. In the depicted embodiment, one or more client computing devices 190 are communicatively coupled to the network 175, such as client computing devices associated with users who perform various transactions in a virtual world provided by one or more computing systems, including receiving item valuations from the VIV system.

The network 175 can be an IP-based network for communication between computer 105 and any external server, client and the like via a broadband or other network connection. The network 175 transmits and receives data between the computer 105 and external systems. In an exemplary embodiment, the network 175 can be a managed IP network administered by a service provider. The network 175 can be implemented in a wireless fashion, e.g., using wireless protocols and technologies, such as WiFi, WiMax, etc. The network 175 can also be a packet-switched network such as a local area network, wide area network, metropolitan area network, Internet network, or other similar type of network environment. The network 175 can be a fixed wireless network, a wireless local area network (LAN), a wireless wide area network (WAN) a personal area network (PAN), a virtual private network (VPN), intranet or other suitable network system and includes equipment for receiving and transmitting signals.

In at least some embodiments, the memory 115 can further include a basic input output system (BIOS) (omitted for simplicity). The BIOS is a set of routines that initialize and test hardware at startup, initiate execution of the OS 145, and support the transfer of data among the hardware devices. The BIOS is typically stored in ROM so that the BIOS can be executed when the computer 105 is activated. When the computer 105 is in operation, the processor 110 is configured to execute instructions stored within the memory 115, to communicate data to and from the memory 115, and to generally control operations of the computer 105 pursuant to the instructions.

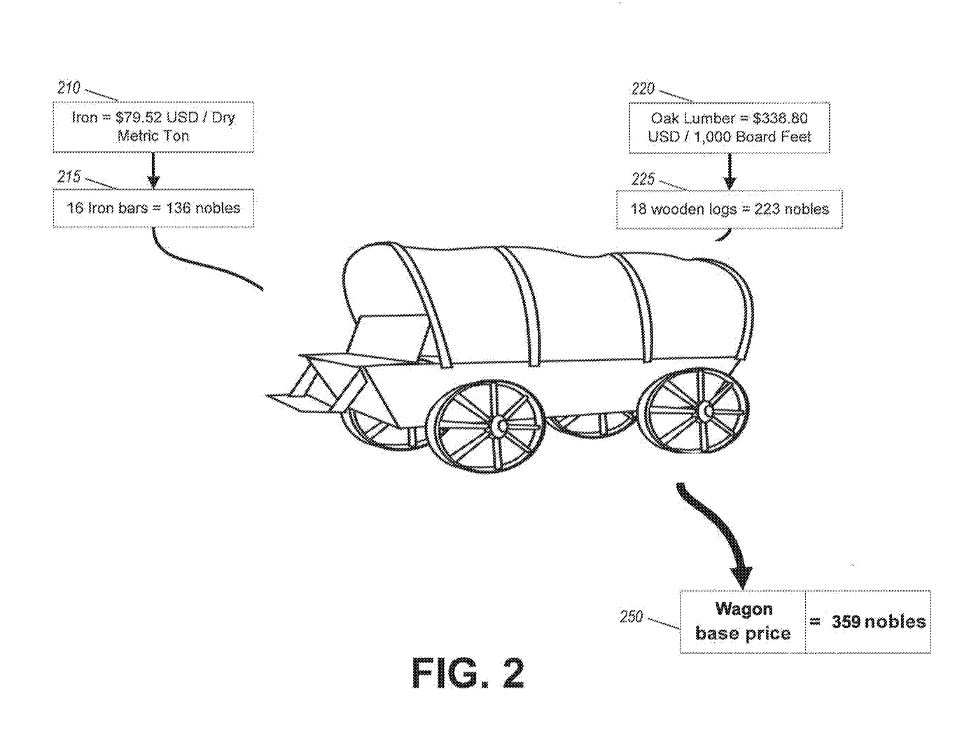

FIG. 2 illustrates an example of assigning a virtual value to a virtual item in a virtual world that uses a virtual currency called a “noble.” In the depicted example, a virtual wagon 200 of a virtual world (not shown) is made up of various virtual materials and virtual components. In particular, virtual wagon 200 includes a quantity of virtual oak logs and iron bars. Each such virtual component can be associated with one or more real-world commodities.

Iron bars in the virtual world are associated with a real-world commodity of iron, which as depicted in block 210 has a real-world commodity price of $79.52 U.S. dollars per dry metric ton. In one or more embodiments, the real-world commodity price can be a current spot price for the commodity, a running average price for the real-world commodity over a predetermined period of time, or some other real-world commodity price to be used by the VIV system in determining a virtual value (in nobles) for the virtual component of an iron bar. As noted in block 215, the wagon includes 16 iron bars, which based on the $79.52/dry metric ton figure and a predetermined relationship between the real world value and the virtual world value, equates to 136 nobles for the quantity of iron bars present in the virtual wagon 200. Pricing the virtual iron bars based on real-world prices results in the fact that the price of the iron bars fluctuates. For example, in the real-world, the price of iron has varied between $177 per dry metric ton to below $40 per dry metric ton between 2011 and 2016. Basing the virtual price of iron bars on the real-world price allows the virtual world to reflect circumstances in the real-world. Such a correspondence of real-world values to virtual values also allows the virtual economy to be more stable.

In a manner similar to that described above with respect to iron bars, block 220 indicates that the real-world commodity of oak lumber has a real-world commodity price of $338.80 per 1000 board feet. Block 225 indicates that the real-world commodity of oak lumber is associated with the virtual component of oak logs, and that the virtual wagon 200 includes 18 such wooden logs—currently equated to 223 nobles in the virtual world. This process can be continued for any other components of virtual wagon 200.

Block 250 indicates a resulting base price for the virtual wagon 200 of 359 nobles. In the depicted example of FIG. 2, this base price is a sum of the virtual value assigned to its component materials. In one or more embodiments, however, a value of a virtual item can be modified by the VIV system in order to adjust for various additional factors. Continuing the example of FIG. 2, a user wishing to initiate creation of the virtual wagon for use in the virtual world can be required to expend a particular amount of time in its creation (such as an amount of time that corresponds to actual construction of a wagon in the real world). In one or more embodiments, a user wishing to initiate creation of the virtual wagon can be required to first obtain one or more specialized tools to create the wagon (e.g., a magical anvil, a specified magic spell, etc.), and the VIV system can alter the valuation assigned to the virtual wagon based on the rarity and/or cost of those specialized tools. In some embodiments, the user can be required to obtain one or more virtual skills within the virtual world (e.g., siege engine construction, advanced blacksmithing, etc.), and the VIV system can alter the assigned valuation based on a difficulty level, experience level, or monetary investment involved in obtaining such skills. In some embodiments, there can be a predetermined markup from the cost of components to the price of the finished virtual item.

In one or more embodiments, the VIV system can maintain one or more data structures to store various data involved in virtual item valuation and pricing structures. For example, the VIV system can maintain one or more data tables associating virtual items with particular real-world commodities; detailing exchange rates between such virtual items and real-world commodities; and storing additional factors regarding the valuation of virtual items within one or more virtual worlds. Furthermore, in one or more embodiments, a virtual item can be associated with multiple real-world commodities, either as a result of having multiple virtual components included in the virtual item or otherwise. For example, the valuation of a virtual fruit-bearing tree can be associated with (and therefore affected by) real-world commodity prices of both frozen orange juice concentrate and one or more types of lumber.

In at least one embodiment, the VIV system can perform various operations in order to adjust over time the assigned virtual value of one or more virtual items in accordance with changes to real-world commodity prices of the real-world commodities associated with the virtual items and/or virtual components of such virtual items. For example, the VIV system can obtain updated real-world commodity prices associated with such virtual items at predefined regular or scheduled intervals, or in response to user requests.

In one or more scenarios, the virtual world can consist of multiple virtual regions that are each associated with one or more real-world locations. For example, a virtual world can be provided using multiple servers such that the user population of the virtual world is segregated into a smaller subset population. Such segregated populations can be identified to the user base as a separate “realm,” “shard,” or other terminology. Typically, users associated with one virtual region can either be unable to interact with users from another region entirely, or be limited in such interactions relative to those that are possible with other users from their own region. As another example, a virtual world can include multiple virtual geographical regions (e.g., continents, planets, quadrants, zones, etc.), to which users can travel by using virtual transportation mechanisms in the virtual world itself. In such embodiments, such virtual regions can be associated with distinct real-world locations, such that virtual items in one virtual region are associated with different real-world commodities than virtual items in another virtual region. For example, virtual items in a virtual region associated with the Americas can be associated with real-world commodity prices in the United States, while virtual items in a virtual region associated with Asia can be associated with real-world commodity prices in China, South Korea, Japan, etc. Accordingly, in various embodiments, the VIV system can determine real-world commodity prices for real-world commodities associated with virtual items by obtaining such prices only from the real-world location associated with a particular virtual region that hosts users of those virtual items.

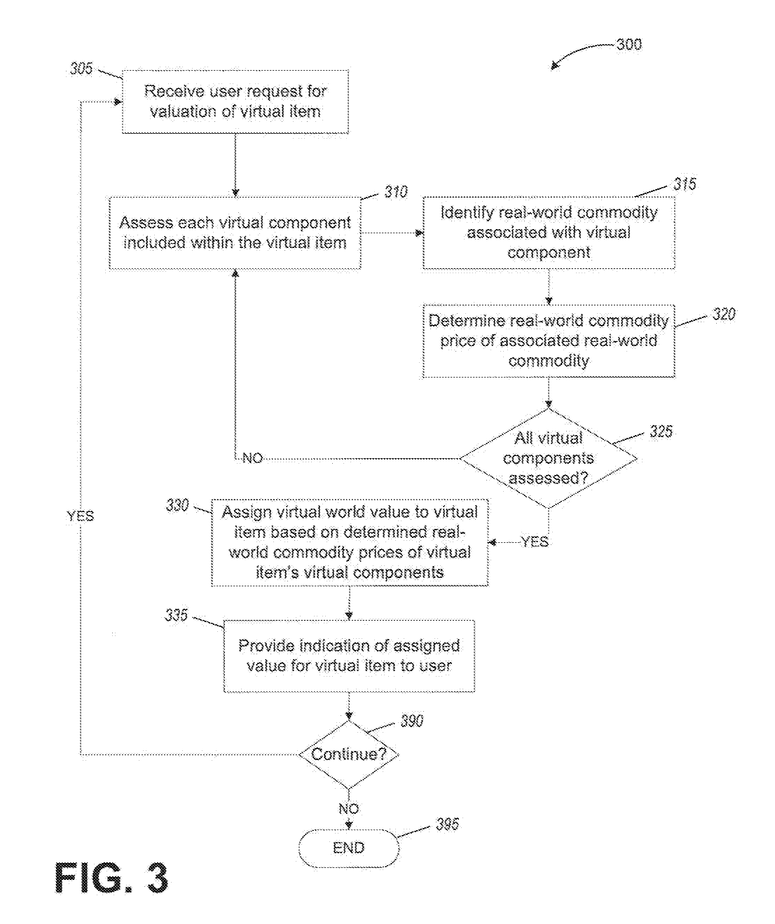

FIG. 3 depicts a process flow routine 300 for operations performed by a Virtual Item Valuation (VIV) system in accordance with one or more embodiments of the present invention. The routine 300 begins at block 305, in which a request for the valuation of a virtual item is received from a user of a virtual world by the VIV system, such as via virtual item manager 112 of FIG. 1. In at least one embodiment, the VIV system can receive the request via a graphical interface provided as part of the virtual world, such as an inventory management system employed by the user to manage a virtual inventory of virtual items, to conduct trades and other transactions within the virtual world, etc. In one or more embodiments, the VIV system can receive the request via one or more programmatic interfaces provided for the virtual world, such as an API or other programmatic interface. In some embodiments, the request can be automatically generated at predefined regular or scheduled intervals. In some embodiments, the request can be a request to initiate creation of the virtual item.

At block 310, the VIV system begins assessing each virtual component included within the virtual item for which valuation has been requested. In certain scenarios, a virtual item can be a “base” item, and can therefore have no component virtual items (such as if the virtual item itself serves as a component in other virtual items within the virtual world). In such case, the assessment is performed with respect to the item itself, such that the routine assesses the item as if it were its own soul virtual component. Referring back to FIG. 2, exemplary base items can include iron bars, wooden logs, and leather strips.

In block 315, the VIV system identifies at least one real-world commodity associated with the virtual component. As described elsewhere herein, in one or more embodiments each virtual component can be associated with multiple real-world commodities. At block 320, the VIV system determines, such as via commodity pricing manager 113 of FIG. 1, a real-world commodity price of the real-world commodity or commodities associated with the virtual component being evaluated. As noted elsewhere herein, each real-world commodity price can be a current spot price for the commodity, a running average price for the real-world commodity over a predetermined period of time, or some other appropriate price structure for the real-world commodity. These costs can be determined in one of a variety of different manners. Spot prices can be determined by accessing a website that lists such prices. Averages can be calculated by determining a price of the commodity over a specified period of time. Different types of averages can be used (e.g., weighted averages).

Additions can be made to the price to account for aspects of creating the virtual item. In some embodiments, the virtual value can further be based on a duration of time used to create the virtual item. In some embodiments, the virtual value can further be based on a value of one or more specialized virtual tools to create the virtual item. In some embodiments, the virtual value can further be based on a rarity of the specialized virtual tools. In other words, the value of an item can include the cost of the virtual tools used to create the virtual item. In other embodiments, a virtual cost of the virtual tools can be a separate cost that is not included with the virtual cost of the virtual item. In some embodiments, the price of an item can include a cost assigned to a difficulty level or experience level associated with a specialized virtual skill used to create the item. In other embodiments, costs associated with tools, experience, and the like are not included with the price of the item because those costs are accounted for in the time required to create the tools or gain experience.

At block 325, the routine determines whether all virtual components of the virtual item have been assessed. If not, the routine returns to block 310 to begin assessment of a next virtual component of the virtual item. If all virtual components of the virtual item have been assessed, the routine proceeds to block 330, in which the VIV system assigns a virtual world value to the virtual item based on the determined real-world commodity prices of the virtual item's components. At block 335, the VIV system provides an indication of the assigned value for the virtual item to the user requesting the valuation.

At block 390, the VIV system determines whether it is to continue, such as in response to receiving an explicit indication to terminate. In the depicted embodiment, if it determines to continue the VIV system routine returns to block 305 to await further requests for virtual item valuation. If in block 390 the routine determines not to continue, the VIV system can end operations of the depicted and/or other routines as appropriate, as shown at block 395.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that in some embodiments the functionality provided by the routine or routines discussed above can be provided in alternative ways, such as being split among more routines or consolidated into fewer routines. Similarly, in some embodiments illustrated routines can provide more or less functionality than is described, such as when other illustrated routines instead lack or include such functionality respectively, or when the amount of functionality that is provided is altered. In addition, while various operations can be illustrated as being performed in a particular manner (e.g., in serial or in parallel) and/or in a particular order, it will be appreciated that in other embodiments the operations can be performed in other orders and in other manners. It will also be appreciated that particular data structures discussed above can be structured in different manners, such as by having a single data structure split into multiple data structures or by having multiple data structures consolidated into a single data structure. Similarly, in some embodiments, illustrated data structures can store more or less information than is described, such as when other illustrated data structures instead lack or include such information respectively, or when the amount or types of information that is stored is altered.

The present invention can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for assigning virtual values to virtual items in a virtual world, the method comprising:
for each of one or more virtual components included in a first virtual item, determining, by the one or more computing systems, a real-world commodity price of a real-world commodity associated with the virtual component; and
assigning, by the one or more computing systems and based at least in part on the determined real-world commodity prices and on the respective quantities of the one or more virtual components included in the first virtual item, a virtual value to the first virtual item.

2. The computer-implemented method of claim 1 further comprising, for each of the one or more virtual components included in the first virtual item, associating the real-world commodity with the virtual component.

3. The computer-implemented method of claim 1, wherein, for at least one of the one or more virtual components, determining the real-world commodity price includes determining a current spot price for the real world commodity.

4. The computer-implemented method of claim 1, wherein, for at least one of the one or more virtual components, determining the real-world commodity price includes determining a running average price for the real world commodity.

5. The computer-implemented method of claim 1, further comprising:
receiving, by one or more computing systems, a request for a valuation within the virtual world of the first virtual item; wherein:
receiving the request includes receiving a request from the user to initiate creation of the first virtual item by the user within the virtual world;
creation of the first virtual item by the user within the virtual world has a duration of time required to create the first virtual item; and
assigning the virtual value to the first virtual item is further based on the duration of time.

6. The computer-implemented method of claim 1, wherein:
receiving the request from the user includes receiving a request to initiate creation of the first virtual item by the user within the virtual world;
creation of the first virtual item by the user within the virtual world requires that the user obtain one or more specialized virtual tools within the virtual world; and
assigning the virtual value to the first virtual item is further based on one or more of a value of the one or more specialized virtual tools and a rarity of the one or more specialized virtual tools.

7. The computer-implemented method of claim 1, wherein:
receiving the request includes receiving a request to initiate creation of the first virtual item by the user within the virtual world;
creation of the first virtual item by the user within the virtual world requires that the user obtain one or more specialized virtual skills within the virtual world; and
assigning the virtual value to the first virtual item is further based on an experience level associated with the one or more specialized virtual skills.

8. The computer-implemented method of claim 1, wherein:
the virtual world comprises multiple virtual regions that are each associated with one or more real-world locations;
the user is associated with a first of the multiple virtual regions;
at least one of the real-world commodity prices varies in accordance with the one or more real-world locations; and
determining the real-world commodity price of the real-world commodity associated with at least one of the virtual components includes determining a real-world commodity price for the real-world commodity within the one or more real-world locations associated with the first virtual region.

9. The computer-implemented method of claim 8, wherein each of the multiple virtual regions corresponds to a virtual geographical region within the virtual world.

10. The computer-implemented method of claim 8, wherein each of the multiple virtual regions corresponds to a subset of computing servers that hosts the virtual world.

11. The computer-implemented method of claim 1 further comprising: adjusting over time the assigned virtual value of the first virtual item in accordance with one or more changes to the real-world commodity price of the real-world commodity associated with at least one of the one or more virtual components included in the first virtual item; and
providing an indication to the user of the assigned virtual value of the first virtual item.

12. A computer program product for assigning virtual values to virtual items in a virtual world based on real-world commodity pricing, the computer program product comprising a computer readable storage medium having program instructions embodied therewith, the program instructions executable by a computing system to cause the computing system to perform a method comprising:
for each of one or more virtual components included in a first virtual item, determining, by the computing system, a real-world commodity price of a real-world commodity associated with the virtual component; and
assigning, by the computing system and based at least in part on the determined real-world commodity prices and on the respective quantities of the one or more virtual components included in the first virtual item, a virtual value to the first virtual item.

13. The computer program product of claim 12 wherein, for at least one of the one or more virtual components, determining the real-world commodity price includes determining a current spot price for the real world commodity.

14. The computer program product of claim 12 wherein, for at least one of the one or more virtual components, determining the real-world commodity price includes determining a running average price for the real world commodity.

15. The computer program product of claim 12, further comprising:
receiving, by one or more computing systems, a request for a valuation within the virtual world of the first virtual item; wherein:
receiving the request includes receiving a request to initiate creation of the first virtual item by the user within the virtual world;
creation of the first virtual item by the user within the virtual world has a duration of time required to create the first virtual item; and
assigning the virtual value to the first virtual item is further based on the duration of time.

16. The computer program product of claim 12, wherein:
receiving the request includes receiving a request to initiate creation of the first virtual item by the user within the virtual world;
creation of the first virtual item by the user within the virtual world requires that the user obtain one or more specialized virtual tools within the virtual world; and
assigning the virtual value to the first virtual item is further based on one or more of a value of the one or more specialized virtual tools and a rarity of the one or more specialized virtual tools.

17. The computer program product of claim 12, wherein:
receiving the request includes receiving a request to initiate creation of the first virtual item by the user within the virtual world;
wherein creation of the first virtual item by the user within the virtual world requires that the user obtain one or more specialized virtual skills within the virtual world; and
assigning the virtual value to the first virtual item is further based on an experience level associated with the one or more specialized virtual skills.

18. The computer program product of claim 12, wherein:
the virtual world comprises multiple virtual regions that are each associated with one or more real-world locations;
the user is associated with a first of the multiple virtual regions;
at least one of the real-world commodity prices varies in accordance with the one or more real-world locations; and
determining the real-world commodity price of the real-world commodity associated with at least one of the virtual components includes determining a real-world commodity price for the real-world commodity within the one or more real-world locations associated with the first virtual region.

19. The computer program product of claim 12, wherein the method further comprises adjusting over time the assigned virtual value of the first virtual item in accordance with one or more changes to the real-world commodity price of the real-world commodity associated with at least one of the one or more virtual components included in the first virtual item.

20. A system for assigning virtual values to virtual items in a virtual world based on real-world commodity pricing, the system comprising:
one or more processors; and
at least one memory, the memory including instructions that, upon execution by at least one of the one or more processors, cause the system to perform a method that includes:
receiving a request for a valuation within the virtual world of a first virtual item, wherein the first virtual item includes a respective quantity of one or more virtual components;
for each of the one or more virtual components included in the first virtual item, determining a real-world commodity price of a real-world commodity associated with the virtual component;
assigning, based at least in part on the determined real-world commodity prices and on the respective quantities of the one or more virtual components included in the first virtual item, a virtual value to the first virtual item; and
providing an indication to the user of the assigned virtual value of the first virtual item.
